(19) United States
(12) Patent Application Publication
(10) Pub. No.: US 2009/0119694 A1
(43) Pub. Date: May 7, 2009

(54) Audience Monitoring of IP Multicast Stream

(75) Inventors: Jean-Baptiste Hennequin, Chatillon (FR); Gilles Bourdon, Issy Les Longjumeau (GB)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 11/989,486

(22) PCT Filed: Jul. 27, 2006
(86) PCT No.: PCT/FR2006/001845

§ 371 Date: Jan. 25, 2008

(30) Foreign Application Priority Data
Jul. 29, 2005 (FR) 05 08178

(51) Int. Cl. H04H 60/33; H04L 12/56

(52) U.S. Cl. 725/9; 370/390; 455/2.01

(57) ABSTRACT

The invention concerns a method for measuring a multicast stream audience, said multicast stream being capable of being replicated by collecting equipment towards user terminals subscribing to said multicast stream. Said method includes a step of transmitting, via at least one collecting equipment to a counting platform, and in accordance with a counting protocol, at least one counting message comprising at least one audience information concerning the replications of the multicast stream by said at least one collecting equipment to at least one user terminal.

The invention relates to the field of telecommunications, and more particularly to Multicast stream audience measurement.

The data transported by Multicast stream can comprise audiovisual data, corresponding for example to television transmissions, radio transmissions, or else videoconferences.

The present invention is of course not limited to Multicast streams transporting audiovisual data. For example, it is possible to download Internet video games. The data corresponding to these video games can be transported by Multicast streams.

In the IP Multicast broadcasting technique, the IP Multicast packets are broadcast by using a particular recipient IP address, termed a Multicast address.

A Multicast stream is characterized by its source address S and by its group address G, and each Multicast stream may therefore be represented by a unique pair (S, G). Two distinct Multicast streams can thus have the same source address S or the same group address G. In the field of broadcasting of televised transmissions, each television channel can correspond to a given group address, or to a given pair (S, G).

The particular feature of Multicast streams pertains essentially to the fact that the support data of these streams are transmitted to a user terminal, for example an audiovisual decoder, on request of the latter transmitted over the IP network.

Asking to receive, or to stop receiving a Multicast stream can be done for example according to the IGMP protocol, for Internet Group Management Protocol, defined at the IETF by recommendations RFC 1112, RFC 2236 and RFC 3376 or according to the MLD protocol, for Multicast Listener Discovery, defined by recommendations RFC 2710, RFC 3810.

On receipt of an access request message, or stream receive request, specifying the desired broadcasting source address, the first item of telecommunication equipment of the IP network capable of interpreting this request message transmits the Multicast data stream corresponding to the desired broadcasting source address to the user terminal from which this request message originates.

An access request message can also pertain to a set of sources for a given group G, the Multicast stream then being designated (*, G) and then corresponding to a sum of the streams transmitted by the various sources to this same group.

A Multicast source transmits the data once to the whole of the network. The network is then in charge of returning these data to appropriate nodes. The nodes replicate the Multicast streams as a function of the decisions taken by the Multicast routing protocol activated by the whole set of nodes.

A particular node of the network which is the first item of telecommunication equipment capable of interpreting this request message and of handling the access request message of the user terminal so as to dispatch the requested Multicast stream to said terminal is called an item of collection equipment.

It may be desirable to measure the audience of a Multicast stream, that is to say at least an indication of the number of user terminals receiving this Multicast stream.

Thus, in the field of radio over Internet, the audience of a given Multicast stream corresponds to the number of Internet-based listeners of a given radio station.

In the field of video games broadcast by Multicast stream, the audience measurement pertains to the number of user terminals having performed or performing a download of these video games.

To measure the audience of a Multicast stream, it is known to interrogate the collection equipment so as to obtain informations contained in a replication table of the item of collection equipment. Each item of collection equipment can provide audience informations limited to the informations in its replication table, for example a number of user terminals to which it transmits the Multicast stream.

Specifically, only the collection equipment have available such an audience-related informations. It is not possible to know what is the total number of user terminals receiving the Multicast stream by observing a single node of the network. Each item of collection equipment can on the other hand allow to have a picture of the number of receivers with respect to the pool of user terminals handled by this item of collection equipment. By interrogating all the collection equipment, and after processing the informations received, it is possible to evaluate the audience of a given Multicast stream.

Thus, it is known to use an item of network administration equipment to perform this interrogation and this processing. Network administration equipments are designed to supervise the network, that is to say for example to verify whether the equipments of the network are operating correctly.

Network administration equipment exhibits the drawback of being relatively unsuitable for the regular collection and for the processing of audience informations. Collection is done by regular interrogation of the whole set of collection equipment so as to upload statistics for each Multicast stream.

In particular, the network administration equipment communicates with the collection equipment using supervision protocols, such as for example SNMP, for Simple Network Management Protocol. When an item of network administration equipment addresses a request to an item of collection equipment, the request message specifies which datum the item of network equipment wishes to recover, for example a number of terminals receiving a given Multicast stream. The supervision protocols being suitable for being able to transmit a wide variety of possible requests, the collection equipment takes a relatively long time to interpret and process the requests received. The use thereof is therefore limited to small scale and localized use.

Moreover, the network administration equipments have to interrogate a relatively high number of items of collection equipments to obtain meaningful data. The network administration equipments consequently have to process a relatively high volume of audience informations. The network administration equipments are not suitable for such processing. The audience informations thus gathered are relatively tricky for a telecommunications operator to utilize, since the audience informations pertain to a counting process and not to the network administration process.

Additionally, it is known in the prior art to use counting platforms that communicate via counting protocols to estimate a connection time to the Internet network or a volume of data exchanged via the Internet for a user. This allows an operator to bill the user according to his consumption. It is possible to cite for example the protocols termed AAA, for Authentication, Authorization, Accounting.

The present invention is aimed at circumventing the abovementioned drawbacks.

According to a first aspect, the present invention provides a method of audience measurement of a Multicast stream, said Multicast stream being replicable by collection equipments to user terminals subscribed to said Multicast stream. Said method comprises a step of transmission, by at least one item of collection equipment to a counting platform, and according to a counting protocol, of at least one counting message comprising at least one audience information relating to a number of replications of the Multicast stream by said at least one item of collection equipment to said at least one user terminal.

The counting protocol is designed to transmit counting data, typically a connection time to the Internet network. The counting protocol thus allows relatively fluid communication of audience informations between the collection equipment and the counting platform, contrary to the supervision protocols used in the prior art to transmit audience cues.

Moreover, the counting platform is designed to process counting data, typically volumes of data exchanged between a user terminal and an Internet network. The counting platform is therefore suitable for processing audience informations, contrary to network administration equipments designed to supervise all or some of the network.

The Multicast stream or streams whose audience is measured can transport audiovisual data, corresponding for example to televised or radiophonic transmissions, or else to videoconferences. Alternatively, the data transported by Multicast stream can correspond to video games. Generally, the present invention is not limited by the nature of the data transported by Multicast stream.

Advantageously, the counting protocol is a protocol of AAA type. The protocols of AAA type and the counting platforms suited to these protocols exhibit the advantage of being relatively commonplace. The method according to an aspect of the invention can thus be implemented relatively easily in existing equipment.

Among the protocols of AAA type may be cited RADIUS, for Remote Authentication Dial In User Service, or else DIAMETER.

The transmission of a counting message from an item of collection equipment to the counting platform can be triggered by the receipt of a command message originating from the counting platform. The counting platform thus interrogates the collection equipment so as to obtain the corresponding audience informations.

Alternatively, the step of transmitting a counting message from an item of collection equipment to the counting platform can be triggered in an autonomous manner. For example, a counter internal to the item of collection equipment makes it possible to determine the instants at which the counting messages have to be transmitted to the platform. According to another example, the item of collection equipment transmits a counting message when the number of replications of a Multicast stream by this item of collection equipment reaches a certain threshold.

According to a second aspect, the present invention provides an item of collection equipment for a system for broadcasting by Multicast stream transmitted over an IP network, the item of collection equipment making it possible to replicate a Multicast stream to at least one user terminal on request of this user terminal, and comprising:
storage means for storing at least one audience information relating to a number of replications of the Multicast stream by the item of collection equipment, and
transmission means for transmitting to a counting platform and according to a counting protocol, counting messages comprising at least one audience information.

Such an item of equipment makes it possible to implement the method according to an aspect of the invention.

According to a third aspect, the invention provides a computer program product intended for an item of collection equipment for a system for broadcasting by Multicast stream transmitted over an IP network, the item of collection equipment making allowing to replicate a Multicast stream to at least one user terminal on request of this user terminal. The computer program is intended to be stored in a memory of a central unit, and/or stored on a memory medium intended to cooperate with a reader of said central unit and/or downloaded via a telecommunication network. The computer program product is characterized in that it comprises instructions for storing at least one audience information relating to a number of replications of said Multicast stream by the item of collection equipment, and for transmitting to a counting platform, according to a counting protocol, counting messages comprising at least one audience information.

According to a fourth aspect, the invention provides a counting platform for measuring the audience of a Multicast stream transmitted over an IP network, said Multicast stream being replicable by collection equipments to user terminals. The counting platform comprises means for receiving at least one counting message transmitted by at least one item of collection equipment according to a counting protocol. Said at least one counting message comprises at least one audience information relating to a number of replications of the Multicast stream by said at least one item of collection equipment having transmitted the counting message. The counting platform also comprises processing means for estimating the audience on the basis of the counting messages received.

Such a counting platform is suitable for operating with the collection equipment according to the first aspect of the invention.

According to a fifth aspect, the invention provides a computer program product intended for a counting platform for measuring the audience of a Multicast stream transmitted over an IP network, said Multicast stream being replicable by collection equipments to user terminals, the computer program being intended to be stored in a memory of a central unit, and/or stored on a memory medium intended to cooperate with a reader of said central unit and/or downloaded via a telecommunication network. The computer program comprises instructions for receiving from at least one item of collection equipment at least one counting message transmitted by said at least one item of collection equipment according to a counting protocol, said at least one counting message comprising at least one audience information relating to a number of replications of the Multicast stream by said at least one item of collection equipment having transmitted the counting message, and for processing the counting messages received so as to estimate the audience on the basis of the counting messages received.

According to a sixth aspect, the invention provides a system for broadcasting Multicast streams comprising:
a source for transmitting at least one Multicast stream over an IP network,
a plurality of items of collection equipment according to an aspect of the invention, each item of collection equipment making it possible to replicate at least one Multicast stream to a plurality of user terminals, and
a counting platform according to another aspect of the invention able to communicate with at least one item of collection equipment according to a counting protocol.

According to a seventh aspect, the subject of the present invention is a counting message structured according to a counting protocol and comprising at least one audience information relating to a number of replications of a Multicast stream by an item of collection equipment to at least one user terminal, the Multicast stream being transmitted over an IP network.

Other features and advantages of the present invention will appear in the description hereinafter.

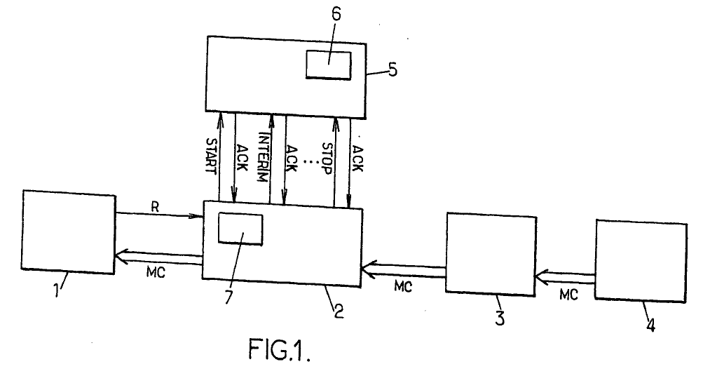

FIG. 1 shows an exemplary system for broadcasting Multicast streams according to a first embodiment of the invention.

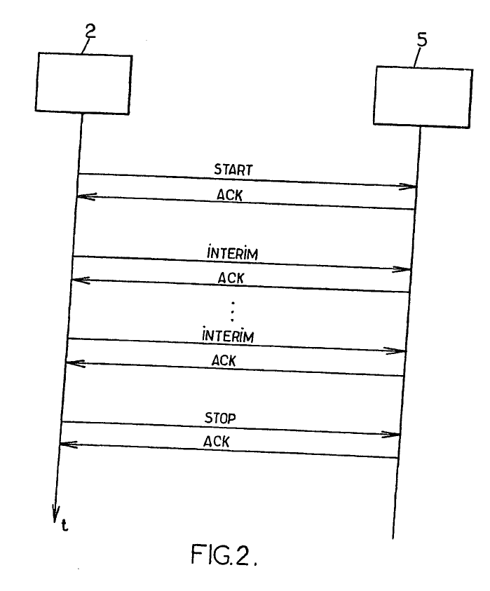

FIG. 2 shows an exemplary communication between an item of collection equipment and a counting platform according to the first embodiment of the present invention.

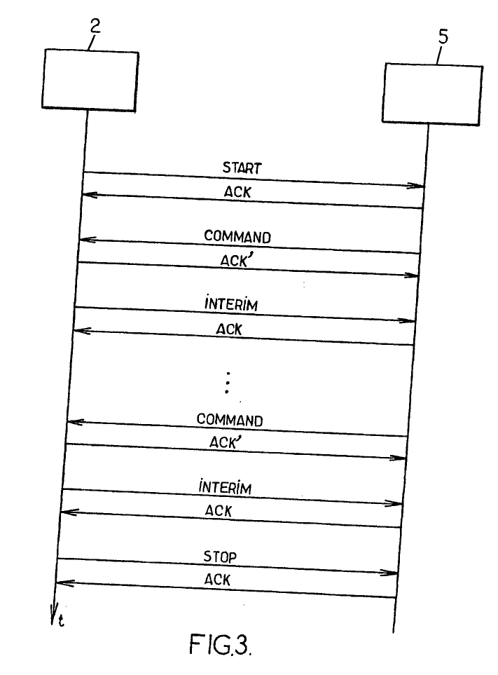

FIG. 3 shows an exemplary communication between an item of collection equipment and a counting platform according to a second embodiment of the present invention.

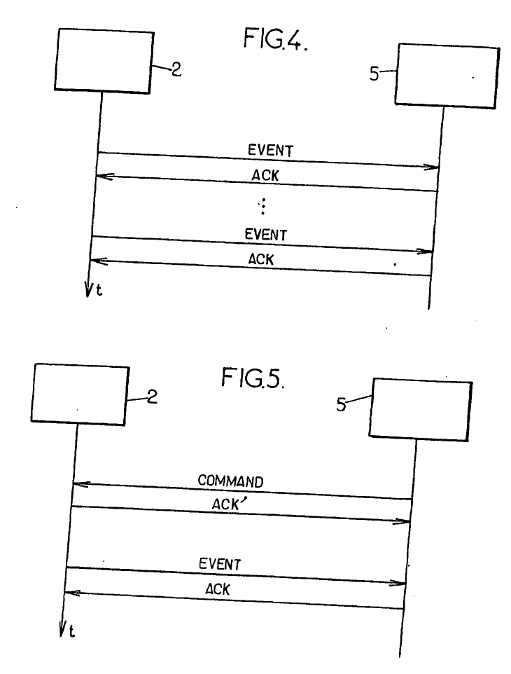

FIG. 4 shows an exemplary communication between an item of collection equipment and a counting platform according to a third embodiment of the present invention.

FIG. 5 shows an exemplary communication between an item of collection equipment and a counting platform according to a fourth embodiment of the present invention.

FIG. 1 shows an exemplary system for broadcasting by Multicast stream. A source 4 transmits at least one Multicast stream MC. The source 4 may transmit a plurality of Multicast streams MC to an IP network 3. Each Multicast stream is then distinguished from the other Multicast streams transmitted by the source 4 by its group address G.

To each group address G there can for example correspond a television channel.

Nodes of the IP network 3 replicate the Multicast streams as a function of the decisions taken by a Multicast routing protocol activated by the whole set of nodes.

A Multicast stream MC is transmitted to a user terminal 1 only following the transmission by this user terminal 1 of a request message R.

A particular node of the network which is the first item of equipment to handle the request message R of the user so as to dispatch the requested Multicast stream to said user is called an item of collection equipment 2.

The request message R is received and interpreted by the item of collection equipment 2.

The item of collection equipment 2 authorizes the replication of the Multicast stream to the user terminal 1 having transmitted the request, possibly after various access control steps which are not detailed here.

Alternatively, the item of collection equipment can interpret the request messages and replicate the requested Multicast stream, the access authorization being granted by an access server distinct from the item of collection equipment.

A Multicast stream transmitted by the source 4 may be replicated via the IP network 3 with a plurality of items of collection equipment 2, of which a single one is represented in FIG. 1. Each item of collection equipment 2 is able to receive request messages R from a pool of user terminals and to replicate the Multicast stream to this pool of user terminals. A single user terminal is represented in FIG. 1.

The request messages R specify the Multicast stream to which a user seeks access. The request messages can comprise for this purpose Multicast stream address fields comprising the group address G, the source address S of the requested Multicast stream or, when the request pertains to a set of sources for a given group, the sum of the streams for the group G represented by the stream (*, G). Each item of collection equipment 2 allows the replication of a single Multicast stream or else of a plurality of Multicast streams.

A counting platform 5 is used to measure the audience of one or more Multicast streams. The counting platform 5 is able to communicate at least with an item of collection equipment 2.

Advantageously, the counting platform 5 is able to communicate with all the collection equipment capable of replicating a given Multicast stream, so as to allow detailed measurement of the audience of the given Multicast stream.

Alternatively, the counting platform is able to communicate with only a part of the collection equipment capable of replicating the given Multicast stream, so as to allow less detailed and therefore faster estimation of the audience.

Alternatively, the counting platform communicates with a single item of collection equipment, so as to measure the audience of a Multicast stream on a given pool of user terminals corresponding to said item of collection equipment.

The item of collection equipment 2 transmits counting messages (for example START, INTERIM, STOP) to the counting platform 5 by using a counting protocol, for example a protocol of AAA type. The counting protocol is designed to transmit counting data and therefore allows relatively fluid transmission of audience informations. Moreover, the counting platform 5 is designed to process counting data and is therefore suitable for processing the counting messages received in order to estimate the audience.

In the example represented in FIG. 1, the counting messages transmitted comprise start-of-counting messages START, intermediate messages INTERIM and end-of-counting messages STOP. The start-of-counting messages START define a session of counting by Multicast stream replicated in the item of collection equipment. Acknowledgement messages ACK are transmitted by the counting platform 5 following the receipt of a counting message. Such a protocol is detailed in FIG. 2.

FIG. 2 shows an exemplary communication between an item of collection equipment 2 and a counting platform 5 according to the first embodiment of the present invention.

In this first embodiment of the present invention, the item of collection equipment 2 transmits to the counting platform 5 counting messages relating to the replications of a given Multicast stream (not represented) only when the replications of this Multicast stream are actually taking place or have just terminated.

A counting session is opened by a start-of-counting message START and is closed by an end-of-counting message STOP. The transmission of the start-of-counting message START is triggered by the start of the first replication of the Multicast stream destined for a user terminal, that is to say upon the first acceptance of a request to access the given Multicast stream. The counting platform 5 dispatches an acknowledgment message ACK following the receipt of the start-of-counting message START.

The counting session ends following the stopping of any replication of the given Multicast stream by the item of collection equipment 2, that is to say when the last user terminal receiving the given Multicast stream ceases to receive this Multicast stream. The counting session therefore continues so long as at least one user terminal receives the given Multicast stream from this item of collection equipment 2.

The start-of-counting message START makes it possible to indicate to the counting platform the replication of the Multicast stream by the item of collection equipment.

The item of collection equipment moreover may transmit intermediate messages INTERIM comprising audience informations on the replications of the Multicast stream. The transmission of the intermediate messages INTERIM is performed subsequently to the transmission of a start-of-counting message, and in the presence of at least one user terminal, subscribed to the Multicast stream at the item of collection equipment. A subscriber user terminal is a terminal that has transmitted a request to access a Multicast stream and is authorized to access this Multicast stream.

The audience informations relating to the replications of the Multicast stream comprise for example:
a number of replications of the Multicast stream, that is to say a number of user terminals having access to the Multicast stream,
a volume, for example in bytes or in packets, of data replicated since the start of the session, or else since the previous intermediate message,
a throughput of replicated data,
a duration of replication of the Multicast stream,
a variation in the number of users since the previous intermediate message, i.e. for example a number of subscriptions to the Multicast stream and a number of desubscriptions.

Of course, the present invention is not limited to these examples.

The transmission of an intermediate message INTERIM is triggered in an autonomous manner in this embodiment. The receipt of the acknowledgment message ACK for the start-of-counting message START activates a monitoring mechanism. Parameters triggering the event for the regular uploading of the audience informations may be defined in a configuration of the item of collection equipment 2.

For example, it is an internal counter, known as such and consequently not represented, which determines when the intermediate messages INTERIM have to be dispatched. In this case, the intermediate messages INTERIM are therefore transmitted at regular time intervals.

Alternatively, the intermediate messages INTERIM may be transmitted each time that the number of user terminals accessing the Multicast stream reaches a certain threshold, for example each time that the number of terminals accessing the Multicast stream is a multiple of 10.

Alternatively, the instants of transmitting intermediate messages are determined by the volume, in bytes or else in packets, of data replicated since the previous intermediate message.

Alternatively, an intermediate message INTERIM is dispatched at each new replication of the (or subscription to the) Multicast stream and at each end of replication of the (or desubscription from the) Multicast stream. The intermediate message INTERIM comprises for example a field advising an identifier of the user terminal newly subscribed to or desubscribed from the Multicast stream. The counting platform thus has an audience cue for each user terminal.

The counting platform 5 transmits an acknowledgment message ACK following the receipt of an intermediate message INTERIM. Upon receipt of the acknowledgment message ACK, the monitoring mechanism is reinitialized, in view of a next transmission of an intermediate message INTERIM. For example, the internal counter which determines when the intermediate messages INTERIM are dispatched is reset to zero.

When the counting session ends, for example when the last user terminal accessing the Multicast stream transmits a request to access another Multicast stream or an end-of-reception request for said Multicast stream, the item of collection equipment 2 transmits an end-of-counting message STOP. The end-of-counting message STOP comprises audience informations relating to the replications of the Multicast stream from the last counting message (INTERIM, START) transmitted, as well as audience cues informing the counting platform of the stopping of any replication. The counting platform 5 transmits an acknowledgment message ACK following the receipt of the end-of-counting message STOP.

The counting platform 5 may thus communicate with a plurality of items of collection equipment. The counting platform 5 receives counting messages transmitted by the collection equipment. Each counting message comprises audience informations relating to the replications of the Multicast stream by the item of collection equipment having transmitted the counting message. The counting platform therefore processes the counting messages received from the collection equipment to estimate the audience of the Multicast stream, on the basis of the informations received from several items of collection equipment.

FIG. 3 shows an exemplary communication between an item of collection equipment and a counting platform according to a second embodiment of the present invention.

In the second embodiment, the item of collection equipment 2 also transmits start-of-counting messages START, end-of-counting messages STOP and intermediate messages INTERIM between a start-of-counting message START and an end-of-counting message STOP. However, the transmission of the intermediate messages INTERIM is triggered by the receipt of a command message COMMAND originating from the counting platform 5, and not in an autonomous manner. The counting platform 5 therefore interrogates the item of collection equipment when a session of a Multicast stream is opened so as to obtain audience cues.

On the other hand, in this example, the transmission of the start-of-counting messages START and respectively of the end-of-counting messages STOP is triggered in an autonomous manner, upon the first replication of the Multicast stream and respectively the stopping of the replications.

In the second embodiment, the item of collection equipment 2 transmits a command message reception acknowledgment message ACK′, following the receipt of the command message COMMAND, and before transmitting an intermediate message INTERIM.

The counting platform 5 transmits a counting message reception acknowledgment message ACK, following the receipt of a start-of-counting message START, of an intermediate message INTERIM or of an end-of-counting message STOP.

The counting platform 5 can be provided with an internal counter (not represented) for determining the instants of transmitting a command message COMMAND. Thus, when a session is open, the item of collection equipment 2 is interrogated at regular time intervals. Alternatively, the time intervals can vary as a function of the audience informations received in the previously transmitted intermediate messages INTERIM.

FIG. 4 shows an exemplary communication between an item of collection equipment and a counting platform according to a third embodiment of the present invention.

In this embodiment, an item of collection equipment 2 transmits an event message EVENT comprising audience informations on the replications of a Multicast stream by the item of collection equipment to at least one user terminal. The transmission of the event message is conditioned by the occurrence of an event of change of state of the item of collection equipment 2.

The event of change of state of the item of collection equipment may for example comprise the reception by the item of collection equipment 2 of a request to access the Multicast stream by a user terminal and the acceptance of this request. Thus, the counting platform 5 is forewarned of each new access to the Multicast stream. In the same manner, the event of change of state of the item of collection equipment may for example comprise the stopping of a replication to a user terminal of the Multicast stream. The counting platform is thus forewarned of each end of access to the Multicast stream.

The event of change of state of the item of collection equipment may also be the doing of a counter (not represented). When the counter reaches a threshold value, the item of collection equipment changes state and transmits an event message comprising audience informations. The counter is reset to zero, in view of a next event message.

The counter may for example allow to count regular time intervals. The counting message comprises an audience information relating to the replications of the Multicast stream by the item of collection equipment, the audience information being able possibly to indicate that said Multicast stream is currently not replicated by the item of collection equipment.

Alternatively, the counter can make it possible to count a number of replications of the Multicast stream: when the number of replications reaches a threshold value, for example a multiple of 100, the item of collection equipment changes state and transmits an event message comprising at least one audience information.

In a fourth embodiment, illustrated in FIG. 5, the change-of-state event comprises the receipt of a command message COMMAND emanating from the counting platform 5. The counting platform 5 interrogates the item of collection equipment 2 on the state of the replications of the Multicast stream. Following the receipt of the command message COMMAND, the item of collection equipment 2 transmits command message reception acknowledgment message ACK′ and an event message EVENT comprising audience informations relating to the replications of the Multicast stream by the item of collection equipment.

The third and fourth embodiments do not involve the concept of session. The event messages EVENT may possibly be dispatched even in the absence of replication of the Multicast stream, in particular when the change-of-state event is the doing of the counter, or comprises the receipt of a command message. The audience information of an event message EVENT may thus possibly indicate that said Multicast stream is currently not replicated by the item of collection equipment. The audience information relating to the replications of the Multicast stream by the item of collection equipment may also possibly indicate that the item of collection equipment performs a single replication of the Multicast stream.

The third and fourth embodiments are for example implemented with the aid of the DIAMETER protocol.

The counting messages comprise an identifier of the Multicast stream, in particular when the counting platform evaluates the audience of several counting streams. This identifier may comprise a group address of the Multicast stream. Alternatively, the identifier comprises a source address and a group address of the Multicast stream. Alternatively, the identifier comprises only a source address of the Multicast stream. In the latter case, it is possible to measure the audience of any stream received by the item of collection equipment originating from a given source.

The counting message may also comprise an identifier of the item of collection equipment having transmitted this counting message, for example an IP address of the item of collection equipment.

When a counting protocol with a counting session is used, the counting message may possibly comprise an identifier of the counting session. The counting platform may easily, on the basis of the counting session identifier, correlate several counting messages relating to one and the same session.

The counting message may also comprise an element making it possible to identify the type of the counting message, for example a start-of-counting message or an intermediate counting message.

The table below presents exemplary embodiments of the present invention, using the RADIUS protocol, defined by recommendations RFC2865, RFC2866 and using the DIAMETER protocol, defined by recommendations RFC3588 and NASREQ, published under the reference draft-ietf-aaa-diameter-nasreq-17.txt.

| | RADIUS | DIAMETER |
|---|---|---|
| Start-of-counting | “Accounting- | “Accounting- |
| message | Request” with the | Request” (ACR) |
| | attribute Acct- | with the AVP |
| | Status-Type = 1 | Accounting- |
| | | Record-Type = 2 |
| Intermediate | “Accounting- | “Accounting |
| message | Request” with the | Request” (ACR) |
| | attribute Acct- | with the AVP |
| | Status-Type = 3 | Accounting- |
| | | Record-Type = 3 |
| End-of-counting | “Accounting- | “Accounting- |
| message | Request” with the | Request” (ACR) |
| | attribute Acct- | with the AVP |
| | Status-Type = 2 | Accounting- |
| | | Record-Type = 4 |
| Event message | Not applicable | “Accounting- |
| | | Request” (ACR) |
| | | with the AVP |
| | | Accounting- |
| | | Record-Type = 1 |
| Multicast stream | Attribute User- | AVP User-Name |
| identifier | Name | |
| Collection | Attribute Nas-IP- | AVP Origin-Host |
| equipment | Address or | AVP Origin-Realm |
| identifier | Attribute NAS- | |
| | Identifier | |
| Counting session | Attribute Acct- | AVP Session-ID |
| unique identifier | Session-ID | AVP Accounting- |
| | | Record-Number |
| Current number of | New attribute | New AVP |
| user terminals | | |
| subscribed to the | | |
| Multicast stream | | |
| Volume | Attribute Acct- | AVP Accounting- |
| transmitted in | Output-Bytes | Output-Bytes |
| bytes to the | | |
| subscribers to | | |
| the Multicast | | |
| stream | | |
| Volume | Attribute Acct- | AVP Accounting- |
| transmitted in | Output-Packets | Output-Packets |
| packets to the | | |
| subscribers to | | |
| the Multicast | | |
| stream | | |
| Duration of | Attribute Acct- | AVP Acct-Session- |
| replication of | Session-Time | Time |
| the Multicast | | |
| stream | | |
| Number of | New attribute | New AVP |
| subscriptions to | | |
| the Multicast | | |
| stream since the | | |
| last counting | | |
| message | | |
| Number of | New attribute | New AVP |
| desubscriptions | | |
| to the Multicast | | |
| stream since the | | |
| last counting | | |
| message | | |

In the aforementioned table, the first four rows correspond to the types of the messages used, the following rows corresponding to the attributes included in these messages to indicate the requested audience informations. The term AVP (Attribute Value Pair) corresponds to the terminology used for the DIAMETER protocol.

The command message COMMAND comprises an identifier of the Multicast stream for which the counting platform requests a state of the audience.

The command message also comprises an identifier of the counting platform transmitting the command message. For security reasons, the platforms authorized to interrogate an item of collection equipment as regards the audience state for a given Multicast stream are declared on this item of collection equipment.

The command messages specify which type of counting message is expected. Alternatively, the counting platform transmits several types of command messages. In this case, the command message also advantageously comprises an element making it possible to identify the type of command message and its subject.

In the case of a RADIUS counting protocol, a message COA, for Change Of Authorization, can be used as command message. In the case of a DIAMETER counting protocol, a message RAR, for Re-Auth-Request, can be used as command message. Other command protocols can be envisaged for transmitting the request for the audience state for a Multicast stream, for example SNMP, COPS, for Common Open Policy Service, or else XML, for Extensible Markup Language.

1. A method of audience measurement of a Multicast stream, said Multicast stream being replicable by collection equipment to a plurality of user terminals subscribed to said Multicast stream, said method comprising transmitting, by at least one item of collection equipment to a counting platform, and according to a counting protocol, at least one counting message having at least one audience information relating to a number of replications of the Multicast stream by said at least one item of collection equipment to at least one user terminal.

2. The method of audience measurement as claimed in claim 1, wherein the counting protocol is a protocol of AAA type.

3. The method of audience measurement as claimed in claim 1, wherein transmitting the counting message comprises:
transmitting a start-of-counting message, the transmitting of the start-of-counting message being triggered by a start of the first replication of said Multicast stream, and
transmitting an end-of-counting message, the transmitting of the end-of-counting message being triggered by a stopping of the last replication of the Multicast stream.

4. The method of audience measurement as claimed in claim 3, wherein transmitting the counting message comprises:
transmitting an intermediate message subsequently to transmitting the start-of-counting message having at least one audience information relating to the replications of the Multicast stream, the transmission of the intermediate message being performed in the presence of at least one user terminal subscribed to said Multicast stream.

5. The method of audience measurement as claimed in one of claims 1 or 2, wherein of transmitting the counting message comprises transmitting an event message having at least one audience information relating to the replications of the Multicast stream, said transmission of the event message being conditioned by an occurrence of a change of state of said item of collection equipment.

6. The method of audience measurement as claimed in claim 5, wherein the change-of-state event is chosen from among the following events:
the item of collection equipment receives from a user terminal a request for access to said Multicast stream and this access request is accepted;
a replication to the user terminal of said Multicast stream is stopped; and
a counter reaches a threshold value.

7. The method of audience measurement as claimed in claim 1, wherein transmitting the counting message is triggered by the receipt of a command message originating from the counting platform.

8. The method of audience measurement as claimed in claim 1, wherein transmitting the counting message is triggered in an autonomous manner.

9. An item of collection equipment for a system for broadcasting by Multicast stream transmitted over a network, the item of collection equipment for replicating a Multicast stream to at least one user terminal on request of said user terminal, comprising:
storage means for storing at least one audience information relating to a number of replications of the Multicast stream by the item of collection equipment; and
transmission means for transmitting to a counting platform and according to a counting protocol, counting messages having at least one audience information.

10. A computer program product for an item of collection equipment for a system for broadcasting by Multicast stream transmitted over a network, the item of collection equipment for replicating a Multicast stream to at least one user terminal on request of said user terminal, the program comprising:
storing at least one audience information relating to a number of replications of said Multicast stream by the item of collection equipment; and
transmitting to a counting platform, and according to a counting protocol, at least one counting message having at least one audience information.

11. A counting platform for measuring the audience of a Multicast stream transmitted over a network, said Multicast stream being replicable by a plurality of collection equipment to a plurality of user terminals, the counting platform comprising:
means for receiving at least one counting message transmitted by at least one item of collection equipment according to a counting protocol, said at least one counting message having at least one audience information relating to a number of replications of the Multicast stream by said at least one item of collection equipment; and
processing means for estimating the audience on the basis of the counting messages received.

12. A computer program product for a counting platform for measuring the audience of a Multicast stream (MC) transmitted over a network, said Multicast stream being replicable by a plurality of collection equipment to a plurality of user terminals, the program comprising:
receiving from at least one item of collection equipment at least one counting message transmitted by said at least one item of collection equipment according to a counting protocol, said at least one counting message having at least one audience information relating to a number of replications of the Multicast stream by said at least one item of collection equipment;
processing the counting message received so as to estimate the audience on the basis of the counting messages received.

13. A system for broadcasting Multicast streams, comprising:
a source for transmitting at least one Multicast stream over an IP network;
a plurality of items of collection equipment, each of the items of collection equipment having a storage means for storing at least one audience information relating to a number of replications of the Multicast stream by the item of collection equipment and a transmission means for transmitting to a counting platform and according to a counting protocol counting messages having at least one audience information, wherein each item of collection equipment is configured to replicate at least one Multicast stream to a plurality of user terminals; and
a counting platform <<means for receiving at least one counting message transmitted by at least one item of collection equipment according to a counting protocol, said at least one counting message having at least one audience information relating to a number of replications of the Multicast stream by said at least one item of collection equipment, and a processing means for estimating the audience on the basis of the counting messages received, wherein the counting platform is configured to communicate with at least one item of collection equipment according to a counting protocol.

14. A computer readable medium encoded with a counting message, wherein the counting message is structured according to a counting protocol, the counting message comprising at least one audience information relating to a number of replications of a Multicast stream by an item of collection equipment to at least one user terminal.
